(19) United States
(12) Patent Application Publication
(10) Pub. No.: US 2007/0144723 A1
(43) Pub. Date: Jun. 28, 2007

(54) Vehicle remote control and air climate system

(76) Inventors: Jean-Pierre Aubertin, Laval (CA); Martin Tessier, Laval (CA); Patrick Noel, Ste-Marthe-sur-le-Lac (CA); Philippe Meilleur, Montreal (CA)

Correspondence Address: ROBIC, CENTRE CDP CAPITAL, 1001, VICTORIA SQUARE - BLOC E - 8TH FLOOR, MONTREAL, QC, H2Z 2B7, CA

(21) Appl. No.: 11/637,059

(22) Filed: Dec. 12, 2006

Related U.S. Application Data
(60) Provisional application No. 60/749,060, filed on Dec. 12, 2005.

(51) Int. Cl. F24F 7/00; B60H 1/00

(52) U.S. Cl. 165/202; 236/49.3

(57) ABSTRACT

Vehicle remote control and air climate system having a remote control device for sending wireless control signals, a receiver at a vehicle for receiving the wireless control signals from the remote control device and generating receiver control signals, a remote controller at the vehicle for receiving the receiver control signals from the receiver and generating remote control signals, a climate controller at the vehicle for receiving the remote control signals from the remote controller and generating climate control signals, and climate control device at the vehicle for receiving the climate control signals from the climate controller and controlling a climate environment of the vehicle.

### FIELD OF THE INVENTION

The present invention relates to a vehicle control and air climate system.

### BACKGROUND OF THE INVENTION

As it is well known, existing remote car starters are used to start the vehicle's main engine to indirectly heat or cool the passenger's cockpit. This is based on the fact that heating/cooling is generated by the main combustion motor which is also the vehicle's drive. However, with this known car starter it is not possible to directly control the climate system of the vehicle.

### SUMMARY OF THE INVENTION

According to the present invention, there is provided a vehicle remote control and air climate system comprising:
a remote control device for sending wireless control signals;
a receiver at a vehicle for receiving the wireless control signals from the remote control device and generating receiver control signals;
a remote controller at the vehicle for receiving the receiver control signals from the receiver and generating remote control signals;
a climate controller at the vehicle for receiving the remote control signals from the remote controller and generating climate control signals; and
climate control means at the vehicle for receiving the climate control signals from the climate controller and controlling a climate environment of the vehicle.

Preferably, the vehicle remote control and air climate system includes a selectively operable air climate remote control device or a combination of climate remote control devices. The air climate remote control device may ultimately control an electrically powered heating and/or a conditioning and/or a ventilating system or any other specifically designed apparatus for selectively heating or cooling the vehicle, for example. The vehicle remote control and air climate device may also include at least one remote transmitter, a receiver at the vehicle for receiving signals from at least one remote transmitter and a controller at the vehicle. The controller may be connected to the receiver for performing at least one vehicle function based upon signals from the remote transmitter, and may also selectively operate the air climate device.

Preferably, the system comprises either alone or in combination:
a remote control system for controlling the original vehicle climate control system which can be composed of an electric heater and/or an electric air conditioner with associated air circulating system;
a remote control system for controlling the original vehicle climate control system which can be composed of an electric heater and/or an electric air conditioner with associated air circulating system and an associated electricity generator;
a remote control system for controlling the original vehicle climate control system which can require the ignition of a non-main drive combustion motor with associated air circulating system;
a remote control system for controlling the original vehicle climate control system which can be composed of a combustible heater and/or a combustible air conditioner with associated air circulating system; or
a remote control system for controlling the original vehicle climate control system which can be composed of but not limited to any specifically designed heater and/or air conditioner apparatus with associated air circulating system.

Preferably, the remote control system may be used for controlling the original vehicle manufacturer climate control system and/or an added climate control system. The remote control system may set remotely the temperature to a pre-fixed temperature or to a remotely fixed temperature.

Preferably, the remote control system requires a security bypass and/or other modification(s) to be performed to the air climate system in order for the system to work.

Preferably, the remote control system requires security confirmation in case any kind of reject will be performed (gas or other) for climate system to be activated, by the user and/or by an intelligent system and/or using sensor(s) to determine if there is any potential danger for human life (GPS signal receiving, for example).

Preferably, the remote control system includes additional optional features like security enhancement, door lock features and other similar remote actions, using any kind of link including data bus communications.

### BRIEF DESCRIPTION OF THE DRAWING

FIG. 1 is a schematic bloc diagram for integration of the system in a vehicle to remotely control air climate, according to a preferred embodiment of the present invention.

### DETAILED DESCRIPTION OF THE INVENTION

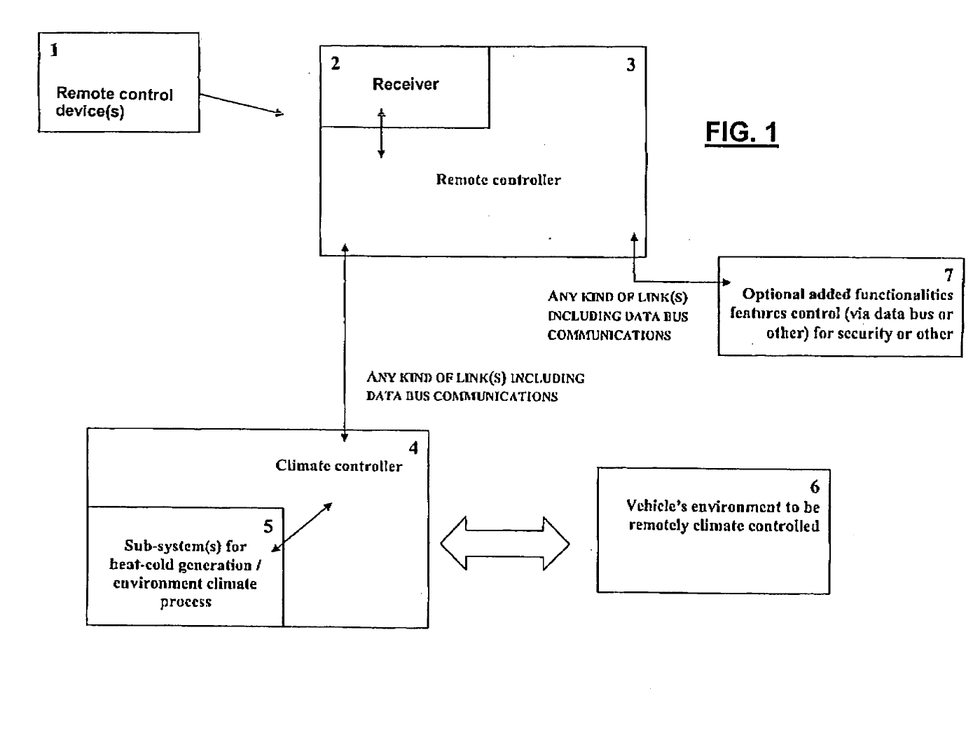

Referring to FIG. 1, there is shown a vehicle remote control and air climate system according to a preferred embodiment of the present invention. The vehicle remote control and air climate system includes a remote control device 1 for sending wireless control signals, a receiver 2 at a vehicle for receiving the wireless control signals from the remote control device 1 and generating receiver control signals, a remote controller 3 at the vehicle for receiving the receiver control signals from the receiver 2 and generating remote control signals, a climate controller 4 at the vehicle for receiving the remote control signals from the remote controller and generating climate control signals, and a climate control subsystem(s) 5 at the vehicle for receiving the climate control signals from the climate controller 4 and controlling a climate environment of the vehicle 6.

The remote control device 1 or transmitter may send its signal(s) by radio-frequency modulation (RF), by infrared (IR) or by any other remote signal(s) that may be physically activated or not, including activation by a computer, home automation system, by internet or by any other network.

The receiver 2 receives the signals from at least one remote control device 1 or transmitter, which may or may not be integrated in the remote controller 3.

The remote controller 3 operates actions of the remote control system. It may need to perform security bypass in the vehicle and/or may need gas emission confirmation from the user, from an intelligent system or from any combinations of sensors, in order to allow, for example, the ignition of a combustible heater. The remote controllers program may be upgradeable, schedulable, locally or remotely. It may use an external card for its program and/or its features. It may be compatible with a plurality of subsystems and may recognize automatically in which car make/brand/model/year it is connected in order to perform corrects actions.

The climate controller 4 controls the climate system apparatus of the vehicle that may be from the vehicle manufacturer or from an added climate system. The climate controller may be integrated in the remote controller 3, which may need modifications to be performed in order to allow remote climate control.

The climate control sub-system(s) 5 is for heat or cold generation. It may be composed, for example, of an electric heater and/or air conditioner, combined or not with an electricity generator, and/or any kind of combustible heater/conditioner and/or any apparatus used for climate control, including a combustion motor that is not the vehicle's main motor drive directly. The cold/heat generator may be added or the original from the vehicle manufacturer may be used, with or without the need to perform modifications in order to allow remote climate control.

Preferably, there are provided optional vehicle functionality control 7 for security bypass or security enhancement, and/or door locks features or any similar features, using the data bus of the vehicle or not.

Advantageously, with the system of present invention, there is provided a remote control system that climates the vehicle's cockpit, whichever the way that the vehicle may be powered now or in the future. This means that the remote control system may control an electric heater remotely, or any kind of specifically designed combustible heater (gas, propane, hydrogen or any kind), or any appliance that may be used to climate the vehicles.

In the case the vehicle uses an electric heating/cooling system; it could imply the need to start an electric generator, optionally or not, as a consequence of the remote command. In case the heat is generated by the coolant of an electric generator (which generator would be mainly used to drive main electric motors drives for a vehicle), the remote feature doesn't start the motor directly, but commands the cockpit heating/cooling by enabling the heating/cooling function in a said vehicle, which would indirectly conduct to starting a combustion motor. This could require or not to modify the original vehicle climate system for permitting the start of the motor if needed. If the presence of a key is required for enabling heating command and indirectly start a motor, the difference would reside in the fact that it is not the remote climate controller that jumps the start wire to force engine to start, but the system itself commands the start of the motor. So this is an indirect remote motor starting, It may also require the need to confirm the location of the car to ensure possible gas emission in the case it will generate some, which confirmation may come from the user, form an intelligent system and/or combination of sensors (to mention GPS signal receiving as an example).

With the present invention, it is possible to remotely enable the climate control, to a preset/standard temperature (say 20 degrees), or to a temperature that could be controlled remotely as user want (user selectable on its remote control). One has to keep in mind that in the future, energy will be managed more tightly to minimize wasting, so the temperature won't go to its maximum possible, unless requested, like it is today.

The present invention may work with any suitable remote control methods, whichever the path(s) the command passes through. For example, it is possible to command the climate control by internet, or the commands may travel through many kinds of networks, then reach the cellular phone network and then be received by the system of the present invention. It could also simply be a standard known remote control as currently used, enhanced or not with temperature control adjustment.

The system of the present invention may use the vehicle's data bus to control the climate control or any other way (direct wire connect or combinations of wire connect).

The system of the present invention may command an aftermarket climate system or an “upgrade” system also, installed on a vehicle, or the original system of the vehicle manufacturer. It should include all modifications needed to be applied on the vehicle in order to be able to control the climate.

The system of the present invention allows the user to not necessarily perform a direct action for the system to be remotely activated. For example, in the future an intelligent house system may detect a user's life habits and detect that the user is leaving soon using the user's vehicle, it could command remotely to activate the climate system. Also, some detectors with personal identification IDs may detect that a user is going to the user's vehicle, and this may also command the remote climate system.

The system of the present invention may include additional control features such as door locks or any other similar feature and/or additional security features (bypass and/or enhancement), whichever the kind of link is required (data bus or direct wire).

The system of the present invention may be remotely updatable by means of a schedule controller. In this way, one may program a schedule in the car to climate the cockpit at predefined times (this may imply a kind of activation/confirmation).

Although preferred embodiments of the present invention have been described in detail herein and illustrated in the accompanying drawing, it is to be understood that the invention is not limited to these precise embodiments and that various changes and modifications may be effected therein without departing from the scope or spirit of the present invention.

1. Vehicle remote control and air climate system comprising:
a remote control device for sending wireless control signals;
a receiver at a vehicle for receiving the wireless control signals from the remote control device and generating receiver control signals;
a remote controller at the vehicle for receiving the receiver control signals from the receiver and generating remote control signals;
a climate controller at the vehicle for receiving the remote control signals from the remote controller and generating climate control signals; and
climate control means at the vehicle for receiving the climate control signals from the climate controller and controlling a climate environment of the vehicle.

2. The system according to claim 1, wherein the receiver is integrated in the remote controller.

3. The system according to claim 1, wherein the climate controller is integrated in the remote controller.

4. The system according to claim 1, wherein the climate control means is integrated in the climate controller.

5. The system according to claim 1, wherein the climate control means includes a heat or cold generator.

6. The system according to claim 1, wherein the remote controller is connected to the climate controller via a data bus link.

7. The system according to claim 1, wherein the remote controller is connected to a security bypass system via a data bus link.
